(19) United States
(12) Patent Application Publication
(10) Pub. No.: US 2004/0128208 A1
(43) Pub. Date: Jul. 1, 2004

(54) Procurement management system and method

(76) Inventor: Ming Fang Tsai, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/404,333

(22) Filed: Mar. 31, 2003

(30) Foreign Application Priority Data
Dec. 25, 2002 (TW) 91137233

(51) Int. Cl. G06F 17/60

(52) U.S. Cl. 705/26

(57) ABSTRACT

A procurement management system includes a local database server (15), remote database servers (16), and an application server (12). The application server includes an authorization control module (120) for defining operational rights and a scope for each user of the system; a data maintenance module (121) for adding, modifying, deleting and searching information in the local database server; a purchase requisition management module (122) for generating purchase requisition bills, and modifying or deleting purchase requisition bills; a purchase order management module (123) for generating purchase orders, modifying or deleting purchase orders, and sending purchase orders to corresponding suppliers; a price inquiry management module (124) for determining desired suppliers according to price inquiry records, quotations, price negotiation records, and price comparison records; and a checking and approval management module (125) for a user to examine and approving purchase requisition bills and purchase orders online, and for checking materials delivered by suppliers.

### BACKGROUND OF THE INVENTION

1. Field of the Invention

The present invention relates to procurement management systems and methods, and particularly to a procurement management system and method that provides operations of price inquiry, price negotiation and price comparison in conjunction with an external network. This application relates to a contemporaneously filed application having the same applicant, the same assignee and the same title with the invention.

2. Background of the Invention

Procurement management implements and controls procurement procedures of a company, and manages suppliers of the company systematically. Efficient procurement management can make the suppliers serve the company better, and promote cooperation between the company and the suppliers. Major objectives of procurement management are to determine reasonable ordering quantities, select excellent suppliers, and help the company maintain optimal stock levels.

Traditional procurement methods generally depend on human effort to carry out purchasing procedures. For example, a company may distribute procurement information through newspapers and magazines, and may communicate with its suppliers by ordinary mail or telephone. Labor-intensive work is slow and can be unduly expensive. In addition, it is relatively difficult for supervisors to monitor purchasing procedures that are conducted manually. As a result, the likelihood of errors going undetected is relatively high, which detracts from the reliability of such procedures.

With the recent rapid development of computer science and information technology, electronic purchasing and online purchasing are gradually replacing more traditional labor-intensive purchasing procedures. Electronic and online purchasing have considerable advantages. For example, a purchasing company releases procurement information via an external electronic communications network. Manufacturers then access the information, and bid online for the right to be the company's supplier. In another example, a purchasing company and its suppliers set up electronic information systems linked to each other by an external network such as the Internet. The purchasing company can inquire about prices of material and send purchase orders to suppliers through the external network. The suppliers provide quotations and delivery status information to the purchasing company. In these ways, online purchasing simplifies traditional procedures, improves efficiency, and reduces costs.

Systems and methods for purchasing material with the assistance of computer science and information technology are disclosed in publications such as US Published Patent Application No. 2002143692 published on Oct. 3, 2002 and entitled “Fully Automated, Requisition-Driven, . . . Centralized E-Procurement System . . . J.I.T. . . . ” This patent application provides a system for selecting suppliers by way of bidding online. The main functions of the system include handling and pooling of requisition bills; order formulation, processing and tracking; consolidated, distributed, and other shipping arrangements; procurement accounting and payment authorization; supplier-relations administration; centralized procurement catalog management; procurement data analysis and report and alert generation; and procurement needs analysis.

This patent application discloses an art of handling requisition bills and purchase orders, and managing relations with suppliers. However, the patent application does not deal with means for checking and approving purchase requisition bills and purchase orders online. Thus, a system and method for purchasing material online that successfully addresses the above-mentioned shortcomings is desired.

### SUMMARY OF THE INVENTION

Accordingly, a main objective of the present invention is to provide a procurement management system and method whereby users can check and approve purchase requisition bills and purchase orders online.

To achieve the above objective, a procurement management system in accordance with a preferred embodiment of the present invention comprises: a local database server comprising a local database for storing data in purchase requisition bills and purchase orders, price inquiry records, quotations, price negotiation records, price comparison records, and information on suppliers; a plurality of remote database servers, each remote database server comprising a supplier database for storing information of a corresponding supplier; an application server; and a plurality of client computers connected to the application server through a network. The application server comprises an authorization control module for defining operational rights and a scope for each of users of the system; a data maintenance module for adding, modifying, deleting and searching information in the local database server; a purchase requisition management module for generating purchase requisition bills, and modifying or deleting purchase requisition bills; a purchase order management module for generating purchase orders, modifying or deleting purchase orders, and sending purchase orders to suppliers; a price inquiry management module for determining desired suppliers according to price inquiry records, quotations, price negotiation records and price comparison records; and a checking and approval management module for a user to examine and approve purchase requisition bills and purchase orders online, and for checking materials delivered by suppliers.

Further, the present invention provides a procurement management method that can be implemented using said procurement management system. The method preferably comprises the steps of: (a) generating purchase requisition bills automatically according to purchase requisition information obtained from internal departments of an organization; (b) checking the purchase requisition bills online; (c) carrying out operations of price inquiry, price negotiation, and price comparison, generating corresponding records, and determining one or more desired suppliers according to price inquiry records, price negotiation records and price comparison records; (d) generating purchase orders according to the purchase requisition bills, and checking the purchasing orders online; (e) sending the purchase orders to the one or more desired suppliers; (f) checking materials delivered by one or more suppliers according to purchase orders and quality reports on the materials, accepting the materials if delivery bills coincide with the purchase orders, and if the quality of the materials is satisfactory, or returning the materials to the one or more suppliers if the delivery bills do not coincide with the purchase orders, or if the quality of the materials is not satisfactory; and (g) if the materials are accepted, balancing procurement accounts according to the purchase orders, and generating balancing records.

Other objects, advantages and novel features of the present invention will be drawn from the following detailed description with reference to the attached drawings, in which:

### BRIEF DESCRIPTION OF THE DRAWINGS

FIG. 1 is a schematic diagram of hardware configuration of a procurement management system in accordance with a preferred embodiment of the present invention, the system including an application server, a plurality of client computers and a plurality of remote database servers;

FIG. 2 is a block diagram of main function units of the procurement management system of FIG. 1, but showing only one of the client computers and one of the remote database servers; and

FIG. 3 is a flowchart of a preferred method for implementing the procurement management system of the present invention.

### DETAILED DESCRIPTION OF THE INVENTION

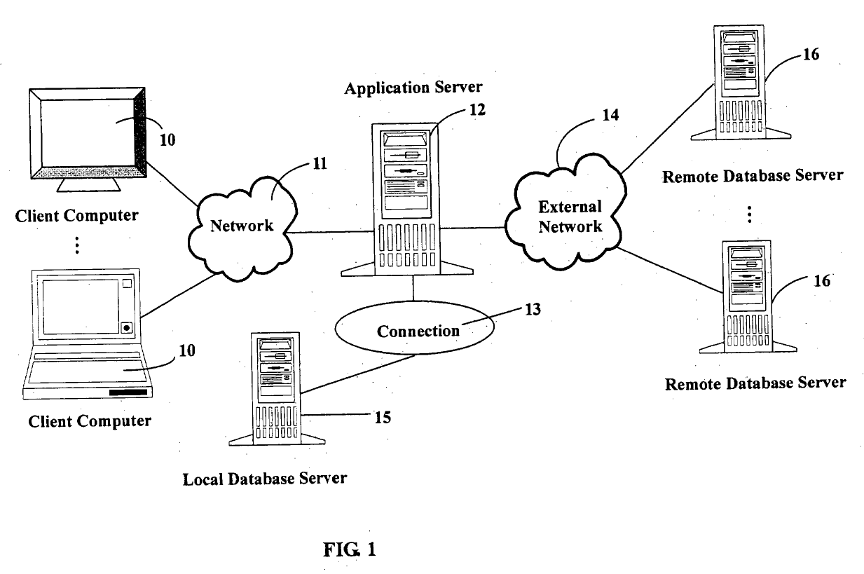

FIG. 1 is a schematic diagram of hardware configuration of a procurement management system in accordance with a preferred embodiment of the present invention. The procurement management system comprises an application server 12, a local database server 15, a plurality of remote database servers 16, and a plurality of client computers 10 connected to the application server 12 through a network 11. The network 11 can be an intranet or the Internet, through which the application server 12 can receive purchase requisition information from the client computers 10 located at various departments of a company. The application server 12 is connected to the local database server 15 through a connection 13. The connection 13 is connectivity such as ODBC (Open Database Connectivity) or JDBC (Java Database Connectivity). Each remote database server 16 is connected to the application server 12 via an external network 14, which may for example be the Internet.

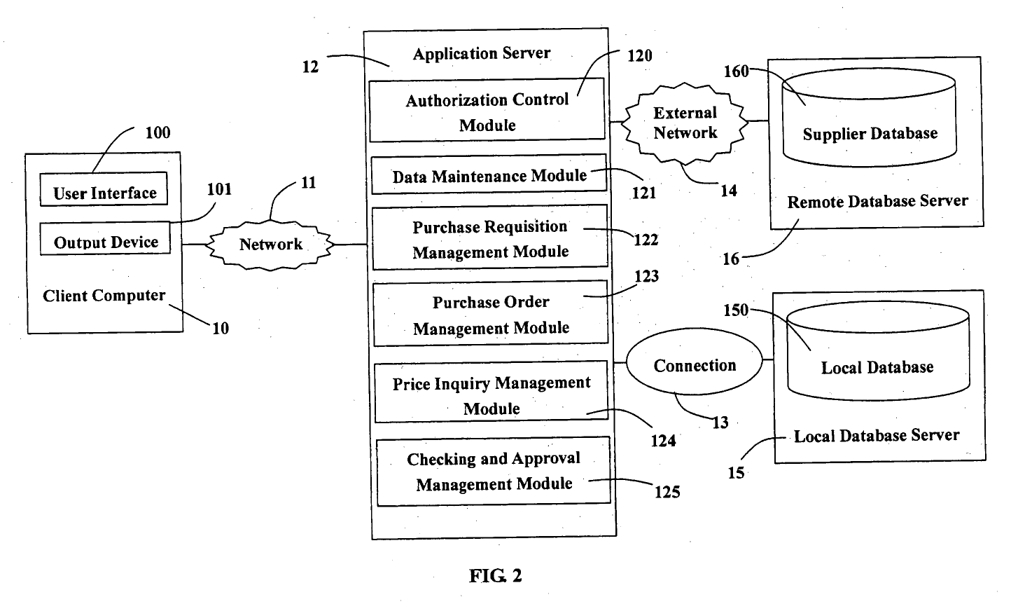

FIG. 2 is a block diagram of main function units of the procurement management system, but showing only one client computer 10 and one remote database server 16. The client computer 10 comprises a user interface 100 and an output device 101. The user interface 100 provides an interactive interface for carrying out operations such as inputting information and data on quotations from suppliers, and for adding, modifying, deleting and searching information in the local database server 15. The output device 101 displays information including data in purchase requisition bills, purchase orders and information on suppliers. The local database server 15 comprises a local database 150 for storing data in purchase requisition bills and purchase orders, price inquiry records, quotations, price negotiation records, price comparison records, and information on suppliers. Each remote database server 16 comprises a supplier database 160 for storing basic information of a relevant supplier.

The application server 12 comprises an authorization control module 120, a data maintenance module 121, a purchase requisition management module 122, a purchase order management module 123, a price inquiry management module 124, and a checking and approval management module 125. The authorization control module 120 defines operational rights and a scope of access for each user of the procurement management system. The data maintenance module 121 is used for adding, modifying, deleting and searching information in the local database server 15. Said information includes data in purchase requisition bills and purchase orders, price inquiry records, quotations, price negotiation records, price comparison records, and information on suppliers. The purchase requisition management module 122 is for generating purchase requisition bills, and modifying or deleting purchase requisition bills. Basic information in a purchase requisition bill includes categories of materials required, requisition quantities, due date for delivery, and expected prices. The purchase order management module 123 is for generating purchase orders, modifying or deleting purchase orders, and sending purchase orders to corresponding suppliers. Basic information in a purchase order includes a number of the purchase order, purchase quantities, specifications of purchased materials, due date for delivery, delivery destination, unit prices and total price, and cash discounts or other payment conditions. The price inquiry management module 124 is for obtaining quotations from suppliers, negotiating with suppliers, and comparing quotations from different suppliers to determine desired suppliers. Basic information in a quotation includes specifications of materials, purchase quantities, due date for delivery, and delivery destination. The checking and approval management module 125 is for examining and approving purchase requisition bills and purchase orders, and checking materials delivered by suppliers.

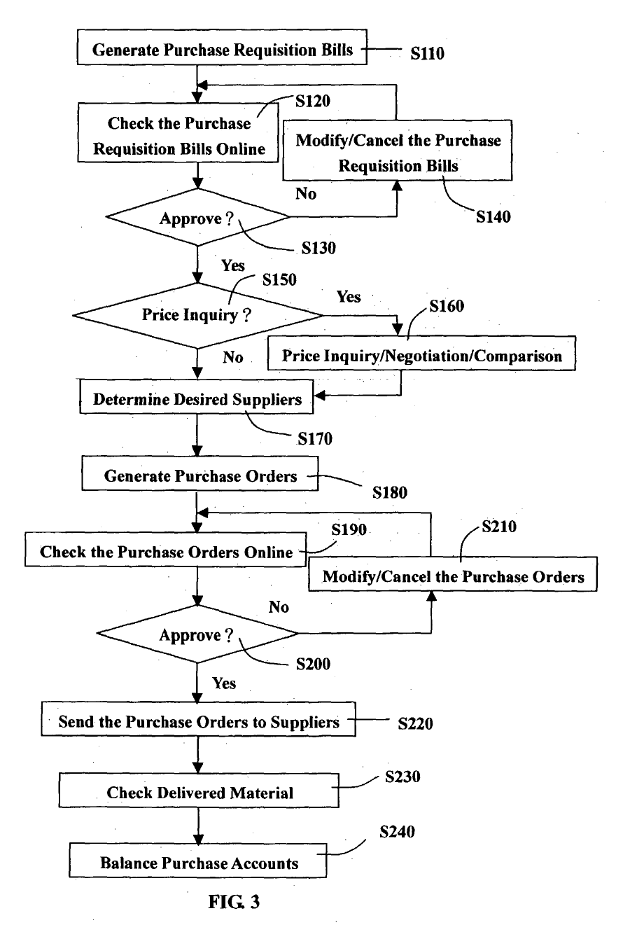

FIG. 3 is a flowchart of a preferred method for implementing the procurement management system of the present invention. In step S110, the purchase requisition management module 122 automatically generates purchase requisition bills according to purchase requisition information received from various departments of the company via the network 11, and stores the purchase requisition bills in the local database 150. Users can maintain the purchase requisition bills through the data maintenance module 121. For example, users can add, modify, delete and search information in the purchase requisition bills. In step S120, users who are authorized by the authorization control module 120 to check purchase requisition bills proceed to check the purchase requisition bills online through the checking and approval management module 125. In step S130, a user having appropriate authority authorized by the authorization control module 120 examines the purchase requisition bills through the checking and approval management module 125. A purchase requisition bill that passes the examination is automatically tagged as having an “approved” status. Only purchase requisition bills that have been approved can be processed further. If any purchase requisition bills are not approved, in step S140, users modify or delete those purchase requisition bills through the purchase requisition management module 122. Said purchase requisition bills are generally sent back to requisitioning departments for modification or cancellation. Any modified purchase requisition bills are then re-checked according to step S120. In step S150, users decide whether to inquire about prices of any materials in the approved purchase requisition bills through the price inquiry management module 124. If price inquiries are not required, the procedure proceeds directly to step S170 described below. If price inquiries are required, in step S160, the price inquiry management module 124 generates price inquiry bills, and sent the price inquiry bills to corresponding suppliers through the external network 14. The suppliers store the price inquiry bills in the respective supplier databases 160, and generate quotations according to the price inquiry bills through the respective remote database servers 16. The quotations are then sent to the application server 12. Then, the price inquiry management module 124 implements operations of price negotiation and price comparison according to the quotations, whereupon the procedure proceeds to step S170.

In step S170, users determine desired suppliers via the price inquiry management module 124. In step S180, the purchase order management module 123 generates purchase orders according to the purchase requisition bills. In step S190, users who are authorized by the authorization control module 120 to check purchase orders proceed to check the purchase orders online through the checking and approval management module 125. In step S200, a user having appropriate authority authorized by the authorization control module 120 examines the purchase orders through the checking and approval management module 125. A purchase order that passes the examination is automatically tagged as having an “approved” status. Only purchase orders that have been approved can be processed further. If any purchase orders do not pass the examination, in step S210, users modify or delete those purchase orders through the purchase order management module 123 according to a predetermined sequence of checking and approval. Any modified purchase orders are then re-checked according to step S190. In step S220, the application server 12 sends the approved purchase orders to corresponding suppliers via the external network 14. In step S230, the suppliers receive the purchase orders, generate quotations according to the purchase orders, and send the quotations to the application server 12. The quotations are stored in the local database 150. When purchased materials are delivered, purchasing operators obtain delivery bills from the deliverer, and check the materials via the checking and approval management module 125 according to the purchase orders and quality reports on the materials. The purchasing operators accept the materials if the delivery bills coincide with the purchase orders, and if the quality of the materials is satisfactory. The purchasing operators return the materials to the suppliers if the delivery bills do not coincide with the purchase orders, or if the quality of the materials is not satisfactory. If the purchasing operators accept the materials, in step S240, the purchasing operators balance procurement accounts, and store balancing records in the local database 150.

Although the present invention has been specifically described on the basis of a preferred embodiment and a preferred method, the invention is not to be construed as being limited thereto. Various changes and modifications may be made to said embodiment and method without departing from the scope and spirit of the invention.

What is claimed is:

1. A procurement management system for checking and approving purchase requisition bills and purchase orders online, the system comprising:
a local database server comprising a local database for storing data in purchase requisition bills and purchase orders, price inquiry records, quotations, price negotiation records, price comparison records, and information on suppliers;
a plurality of remote database servers, each of the remote database servers comprising a supplier database for storing information of a corresponding supplier; and
an application server comprising:
a purchase requisition management module for generating purchase requisition bills, and modifying or deleting purchase requisition bills;
a purchase order management module for generating purchase orders, modifying or deleting purchase orders, and sending purchase orders to suppliers; and
a checking and approval management module for a user to examine and approve purchase requisition bills and purchase orders online, and for checking material delivered by suppliers; wherein
the application server is connected to the remote database servers via an external network, through which the application server sends price inquiry bills and purchase orders to the remote database servers, and accepts quotations from the remote database servers.

2. The system according to claim 1, further comprising a plurality of client computers connected to the application server via a network, whereby users can maintain information in the local database server.

3. The system according to claim 1, wherein the application server further comprises an authorization control module for defining operational rights and a scope of access for each of users of the system.

4. The system according to claim 1, wherein the application server further comprises a data maintenance module for adding, modifying, deleting and searching information in the local database server.

5. The system according to claim 1, wherein the application server further comprises a price inquiry management module for determining desired suppliers according to price inquiry records, quotations, price negotiation records and price comparison records.

6. A procurement management method comprising the steps of:
(a) generating purchase requisition bills automatically according to purchase requisition information obtained from internal departments of an organization;
(b) checking the purchase requisition bills online;
(c) carrying out operations of price inquiry, price negotiation, and price comparison, generating corresponding records, and determining one or more desired suppliers according to price inquiry records, price negotiation records and price comparison records;
(d) generating purchase orders according to the purchase requisition bills, and checking the purchasing orders online;
(e) sending the purchase orders to the one or more desired suppliers;
(f) checking material delivered by one or more suppliers according to purchase orders and quality reports on the material; and
(g) balancing procurement accounts according to the purchase orders, and generating balancing records, if the material is accepted.

7. The method according to claim 6, wherein step (b) comprises the steps of:
(b1) determining a user to check the purchase requisition bills through the authorization control module;
(b2) providing a checking and approval management module for the user to check the purchase requisition bills online;
(b3) determining a user having appropriate authority authorized by the authorization control module to examine the purchase requisition bills online;
(b4) changing any purchase requisition bills that pass the examination to an approved status; and
(b5) modifying or deleting any purchase requisition bills that do not pass the examination.

8. The method according to claim 6, wherein step (d) comprises the steps of:
(d1) determining a user to check the purchase orders through the authorization control module;
(d2) providing a checking and approval management module for the user to check the purchase orders online;
(d3) determining a user having appropriate authority authorized by the authorization control module to examine the purchase orders online;
(d4) changing any purchase orders that pass the examination to an approved status; and
(d5) modifying or deleting any purchase orders that do not pass the examination.

9. The method according to claim 6, wherein step (f) comprises the steps of:
accepting the material if delivery bills coincide with the purchase orders, and if the quality of the material is satisfactory;
returning the material to the one or more suppliers if the delivery bills do not coincide with the purchase orders, or if the quality of the material is not satisfactory.
